(19) United States
(12) Patent Application Publication
(10) Pub. No.: US 2025/0187040 A1
(43) Pub. Date: Jun. 12, 2025

(54) Simultaneous Multi-connector Cleaning and Protection

(71) Applicant: US Conec Ltd., Hickory, NC (US)

(72) Inventors: Darrell R. Childers, Hickory, NC (US); Jason Higley, Hickory, NC (US); Mitchell Cloud, Hickory, NC (US); Jeff Hendrick, Hickory, NC (US)

(21) Appl. No.: 18/974,216

(22) Filed: Dec. 9, 2024

Related U.S. Application Data
(60) Provisional application No. 63/608,072, filed on Dec. 8, 2023.

(51) Int. Cl. B08B 1/14; G02B 6/38

(52) U.S. Cl. CPC B08B 1/143; G02B 6/3831; G02B 6/3866; B08B 2240/02

(57) ABSTRACT

There is a cleaner for cleaning a plurality of fiber optic connectors, each fiber optic connector having fiber optic ferrule that has a main body including a mechanism to move at least one cleaner pad to respective positions adjacent the plurality of fiber optic connectors, a cleaning cloth movable relative to the plurality of fiber optic connectors, wherein the cleaning cloth engages the cleaner pad when the cleaner pad is aligned with one of the end faces and also engages the end face of each of the fiber optic ferrules to clean the fiber optic ferrules, the plurality of fiber optic connectors are ganged together, and wherein the end faces of the plurality of fiber optic ferrules are cleanable in succession one after the other with a single activation of the mechanism. The cleaning cloth may also be flipped between cleanings.

### REFERENCE TO RELATED CASE

This application claims priority under 35 U.S.C. § 119(e) to U.S. provisional application No. 63/608,072 filed on Dec. 8, 2023, the contents of which are hereby incorporated by reference in their entirety.

### BACKGROUND OF THE INVENTION

The end faces of fiber optic connectors can accumulate dust, dirt and debris, all of which have the potential of interfering with the mating of another fiber optic connector or damaging the end face or the optical fibers that are secured within the fiber optic ferrule in the fiber optic connector. There have been a number of cleaners that have been used to adequately clean the end face of a single fiber optic connector. However, the optical fiber world has been moving rapidly from a single optical fiber connector to multi-fiber optical fiber connectors. Even more recently there has been a push to gang these multi-fiber optical fiber connectors. There can be anywhere from 2 to 4 to 8 to 16 or more multi-fiber optical fiber connectors in a single ganging carrier. Cleaning these ganged multi-fiber optical fiber connectors one end face at a time is time consuming, labor intensive and not very trustworthy if the person cleaning them misses one or does not remember which ones have been cleaned and which ones having not. Additionally, these cleaners use a large amount of cleaning cloth and only a small percentage is being used by the cleaner during the cleaning process. Further, typically only one side of the cleaning cloth is used, thereby resulting in wastage of the cleaning cloth.

Thus, Applicant has provided cleaners that can clean multiple multi-fiber optical fiber connectors at the same time in a number of ways, including cleaning from inside an adapter to having the multi-fiber optical fiber connectors inserted into the cleaner. These cleaners use much less cleaning cloth and can even flip the cleaning cloth between cleaning end faces so that there is a clean cloth each time an end face is touched by the cleaning cloth.

### SUMMARY OF THE INVENTION

According to one aspect, the present invention is directed to a cleaner for cleaning a plurality of fiber optic connectors, each fiber optic connector having fiber optic ferrule that includes a main body including a mechanism to move at least one cleaner pad to respective positions adjacent the plurality of fiber optic connectors, a cleaning cloth movable relative to the plurality of fiber optic connectors, wherein the cleaning cloth engages the cleaner pad when the cleaner pad is aligned with one of the end faces and also engages the end face of each of the fiber optic ferrules to clean the fiber optic ferrules, wherein the plurality of fiber optic connectors are ganged together and wherein the end faces of the plurality of fiber optic ferrules are cleanable in succession one after the other with a single activation of the mechanism.

In some embodiments, the mechanism is a cam mechanism to move the at least one cleaner pad upward toward the end faces of the plurality of fiber optic connectors.

In some embodiments, the cam mechanism includes the at least one cleaner pad moving along a vertical axis.

In some embodiments, the cam mechanism includes the at least one cleaner pad being attached to a rotating belt.

In some embodiments, the rotating belt moves the at least one cleaner pad in a direction opposite to a direction of the cleaning cloth.

In some embodiments, the rotating belt moves the at least one cleaner pad in a direction that is the same as a direction of movement of the cleaning cloth.

In some embodiments, the cam mechanism is a rotating belt having a button attached to the rotating belt, the button engaging at least one cleaner pad associated with to move the at least one cleaner pad upward toward the end faces of the plurality of fiber optic connectors.

In some embodiments, the cam mechanism includes a cam shaft that moves the at least one cleaner pad upward toward the end faces of the plurality of fiber optic connectors.

In some embodiments, the cleaner is inserted into an adapter having at least one of the fiber optic connectors disposed therein.

In some embodiments, the plurality of fiber optic connectors ganged together are inserted into the main body of the cleaner.

In yet another aspect, there is a cleaner for cleaning a plurality of fiber optic connectors, each fiber optic connector having fiber optic ferrule that includes a handle, two cleaner tips attached to the handle, the cleaner tips having an open space or a separation therebetween, and a cleaning cloth have a first side and a second side, the cleaning cloth moving from the handle to both of the two cleaner tips and back to the handle, wherein upon activation of the handle, the first side of the cleaning cloth cleans a first of the plurality of fiber optic connectors and the second side of the cleaning cloth cleans a second of the plurality of fiber optic connectors.

In some embodiments, there is a twisting mechanism to twist the cloth between a first of the plurality of fiber optic connectors and a second of the plurality of fiber optic connectors.

In some embodiments, a first of the plurality of fiber optic connectors and a second of the plurality of fiber optic connectors are disposed within an adapter.

In some embodiments, there is at least one connector port of the adapter between the first of the plurality of fiber optic connectors and the second of the plurality of fiber optic connectors.

In some embodiments, the cleaner has at least one keying feature that cooperates with a keying feature on the adapter.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a diagram of one embodiment of a cleaner according to the present invention;

FIG. 2 is a diagram of a second embodiment of a cleaner according to the present invention;

FIG. 3 is a diagram of a third embodiment of a cleaner according to the present invention;

FIG. 4 is a diagram of a fourth embodiment of a cleaner according to the present invention;

FIG. 5 is a diagram of a fifth embodiment of a cleaner according to the present invention;

FIG. 6 is a perspective view of four sets of ganged fiber optic connectors in different ganging arrangements that can be cleaned with the present invention;

FIG. 7 shows one embodiment of a cleaner that cleans the end faces of a set of ganged fiber optic connectors;

FIG. 8 shows spaces for the ganged fiber optic connectors in a cleaner;

FIG. 9 is top view into the opening in the cleaner with the end faces and the cleaning cloth visible

FIG. 10 is a side view of the ganged fiber optic connectors in a cleaner with the guide pads contacting the end faces of the fiber optic ferrules;

FIG. 11 is another variation of the cleaner in FIG. 10 with the cleaning cloth having a longer spacing;

FIGS. 12-14 show another variation of a cleaner according to the present invention and shown with an adapter and fiber optic connectors inserted from one side;

FIGS. 15-17 show another variation of a cleaner according to the present invention and shown with an adapter and fiber optic connectors inserted from one side with the cleaner having a keying element;

FIGS. 18-20 show another variation of a cleaner according to the present invention whereby each of the tips of the cleaner have a different side of the same cleaning cloth.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

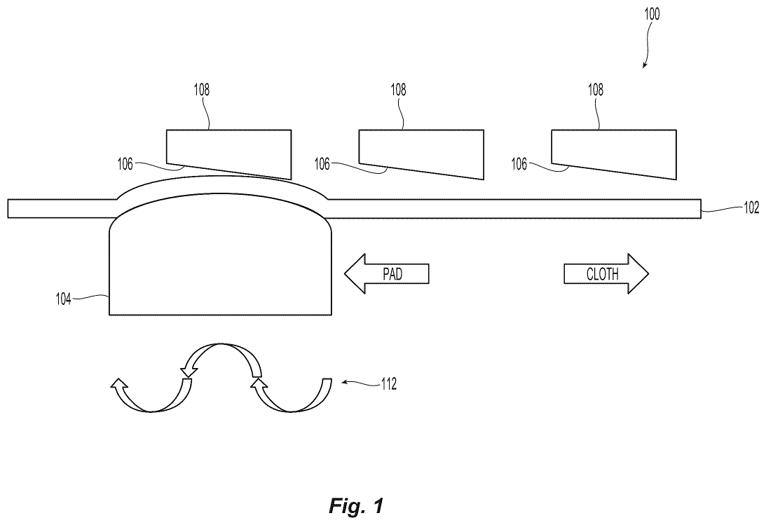

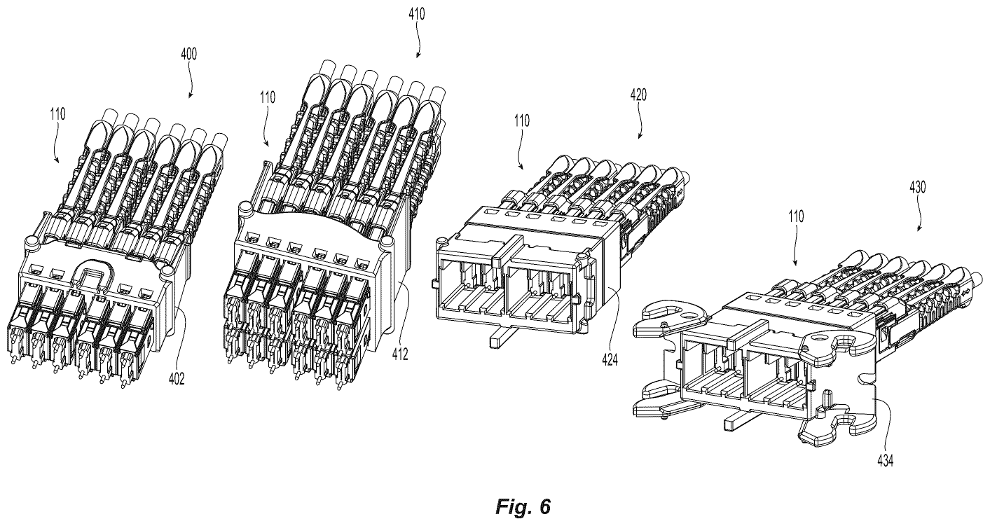

Illustrated in FIG. 1 is a schematic of one embodiment of a cleaner 100 according to the present invention. The cleaner 100 has a cleaning cloth 102 that is used with a pad 104 to clean the end faces 106 of a fiber optic ferrule 108. The cleaning cloth 102 may be spooled within a body of the cleaner 100. Since various such spooling mechanisms are known to one of ordinary skill in the art, they are not being described in detail herein. Further, in various embodiments described herein, only one, or at least one, pad 104 may be used. Furthermore, in all embodiments, only a single activation of the cleaning mechanism cleans all the end faces, for example, either by moving the pad 104 and the cloth 102 through all the end faces, or multiple pads at the same time so the different portions of the cleaning cloth engage the end faces without the end user having to activate the cleaning action twice. Illustrated in the figures are three fiber optic ferrules 108 for the fiber optic connectors 110, but there could be more or fewer. See, e.g., FIGS. 6 & 7 where more than 6 fiber optic connectors 100 are illustrated. The view of the fiber optic ferrules 108 in FIGS. 1-5 is from the top of the connectors, i.e., into the page in FIG. 6. That means that only half of the fiber optic connectors 110 are illustrated in FIGS. 1-5. However, that does not mean that the fiber optic connectors 110 that are not illustrated are not cleaned or necessarily not cleaned all at the same time. As also shown in FIG. 1, the fiber optic ferrule 108 has an angled end face. Alternatively, one or more of the fiber optic ferrules 108 may have a flat end face.

Returning to FIG. 1, there is relative movement between the fiber optic ferrules 108 and the pad 104/cleaning cloth 102. The pad 104/cleaning cloth 102 may be moved or the pad 104/cleaning cloth 102 may be stationary and the fiber optic ferrules 108 may be moved. In this embodiment, the pad 104 and the cleaning cloth 102104/cleaning cloth 102 move in opposition directions. This ensures that the fiber optic ferrules 108 always get a clean portion of the cleaning cloth 102. The arrows 112 show the effective motion of pads 104 relative to the fiber optic ferrules 108. As the pad 104 moves in succession from one to another of the fiber optic ferrules 108, it will engage the end face 106 of the fiber optic ferrules, causing the cleaning cloth 102 to clean the end face 106. However, the pad 104 could also move up and down relative to the end faces 106.

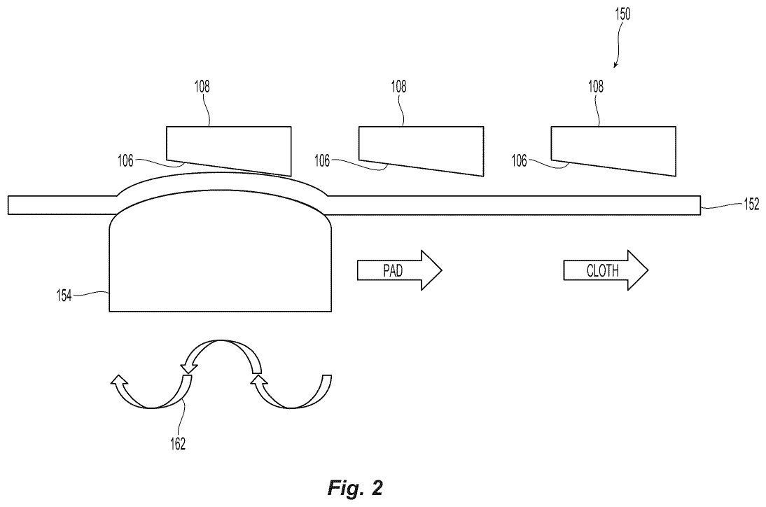

Another embodiment of a cleaner 150 is illustrated in FIG. 2. In this embodiment, the pad 154 moves in the same direction as the cleaning cloth 152. The pad 154 would be moving at a different rate relative to that of the cleaning cloth 152 to allow for a clean portion of the cleaning cloth 152 to engage the end faces 106. In this way, the dirty portion of the cleaning cloth 152 stays on the side of the pad 154 as are the fiber optic connectors 110 that have yet to be cleaned. This prevents cross contamination of the end faces 106. Again, the arrows 162 show the effective motion of the cleaning cloth 102 relative to the fiber optic ferrules 108.

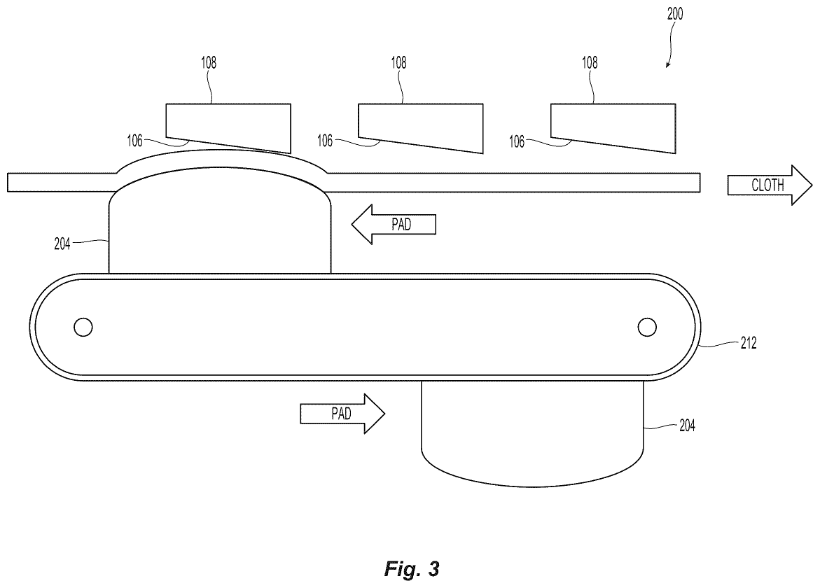

Another embodiment of a cleaner 200 is illustrated in FIG. 3. In this embodiment, the fiber optic connectors 110 are the same and there is a pad 204 and cleaning cloth 202. This embodiment has a rotating belt 212 that acts as a cam mechanism to move the cleaning cloth 202 up to engage the end faces 106 of the fiber optic ferrules 108. The pad 204 is moving opposite the cleaning cloth 202. There is only one pad 204 illustrated in the figure in the cleaning position, but there may be more pads attached to the rotating belt 212.

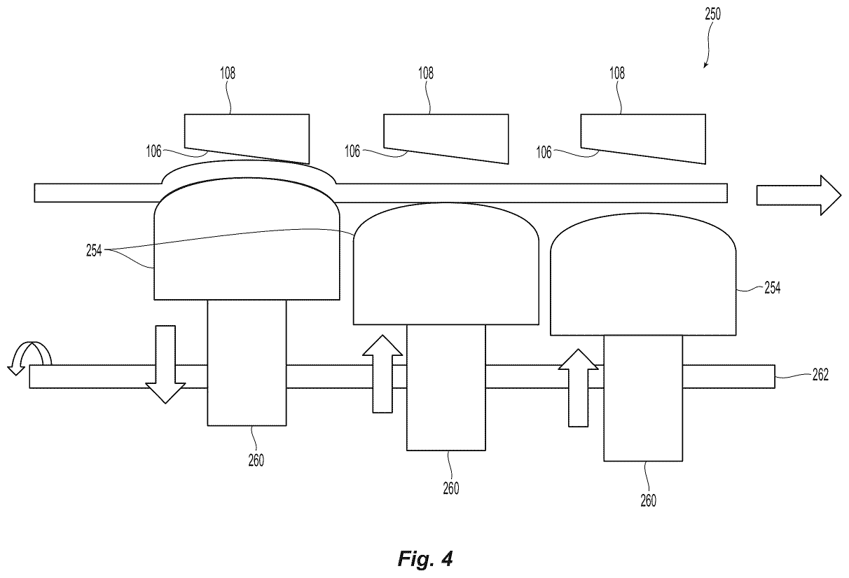

The next embodiment of a cleaner 250 according to the present invention is illustrated in FIG. 4. In the cleaner 250, there is a pad 254 for each of the fiber optic ferrules 108. Each of the pads 254 is aligned under one of the fiber optic ferrules 108 and move upward along a vertical axis to the fiber optic ferrules 108 pressing the cleaning cloth 252 against the end face 106. It will be appreciated by one of ordinary skill in the art after reading this disclosure, that the term “vertical” is relative to the orientation of the cleaner 250 shown in FIG. 4. The pads 254 are rotationally attached to a cam 260 and are moved by their attachment to a cam shaft 262. In this way, the fiber optic ferrules 108 are assured of having a clean portion of the cleaning cloth 252 as the cleaning cloth 252 moves relative to the pads 254.

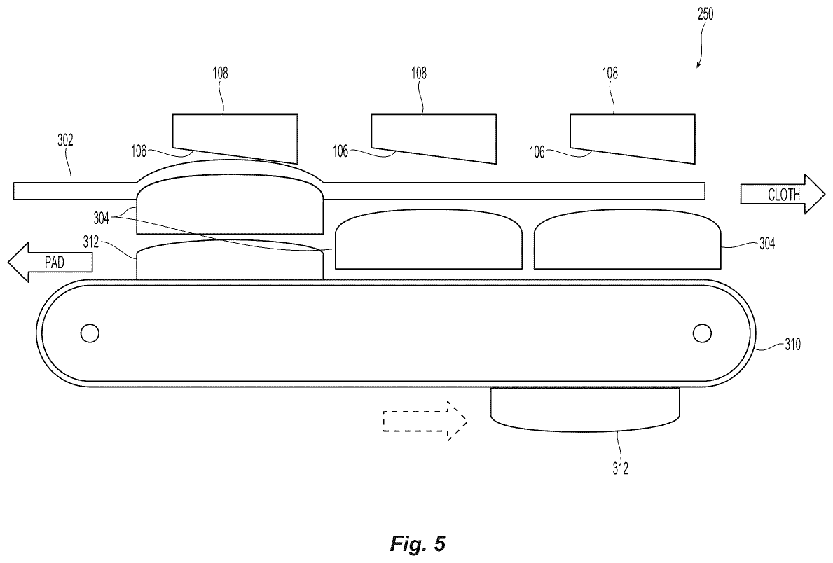

Another embodiment of a cleaner 300 is illustrated in FIG. 5. In this case, the pads 304 are arranged in a position aligned with the end faces 106 of the fiber optic ferrules 108. There is at least one button or protrusion 312 extending from the rotating belt 310. As the rotating belt 310 rotates, the button/protrusion 312 engages the pads 304 and pushes the pad 304 and the cleaning cloth 302 upward onto the end faces 106. This arrangement also keeps the soiled cleaner cloth away from the cleaned end faces 106. That is, the portion of the cleaning cloth 302 that cleans one of the fiber optic ferrules 108 (i.e., and end face 106 thereof) never contacts the end face 106 of another fiber optic ferrule 108 in a given cleaning cycle activation.

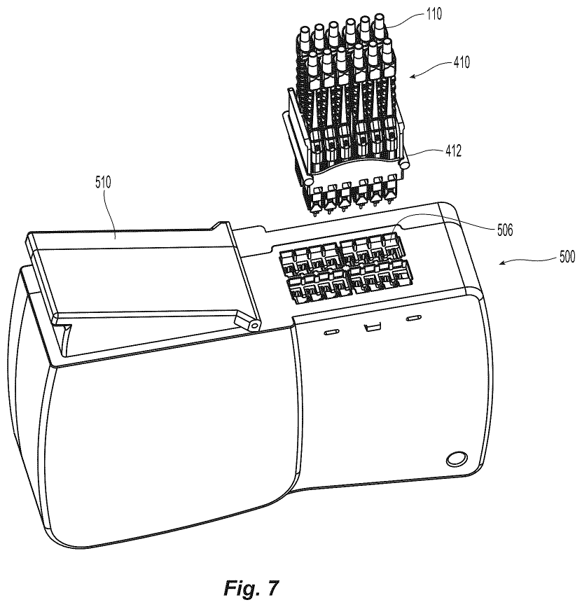

As noted above, the fiber optic connectors 110 are preferably ganged to be cleaned. Illustrated in FIG. 6 are a number of differently ganged fiber optic connectors 110. First is the ganged set 400 of fiber optic connectors 110 with a carrier 402 and is a single row of fiber optic connectors 110. The ganged set 400 of fiber optic connectors are typically cleaned by inserting the ganged fiber optic connectors 110 into an opening in the cleaner. See FIG. 7. Activation of the cleaner drives a mechanism to provide cleaning cloth from one reel and removal of the cleaning cloth with an uptake reel. That activation also causes the movement of the rotating belt, the cams, etc. that move the pads relative to the end faces 106. Naturally all of these components can be neatly packaged in a housing that easily, used, transported and stored. A single activation of the mechanism (e.g., that shown in FIGS. 1-5) simultaneously cleans all the fiber optic connectors 110. Thus, the end user does not activate the mechanism for every end face 106 repeatedly thereby reducing any chances of ergonomic fatigue that may result from cleaning hundreds or thousands of fiber optic connectors 110. However, in an alternative embodiment, instead of the single activation, the user may need to use multiple activations. In that case, the user will clean only one of the end faces 106 and then remove the cleaner 100 from that end face to another end face within the ganged fiber optic connectors 110.

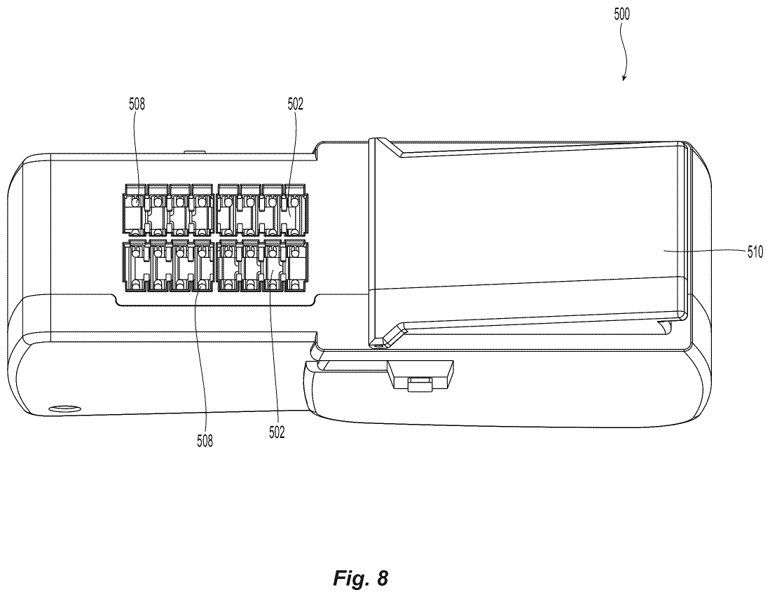

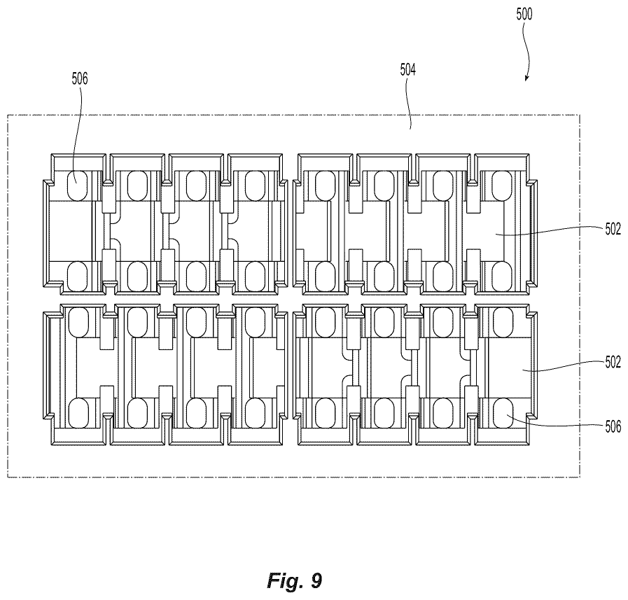

Turning back to FIG. 6, there is another ganged set 410 of fiber optic connectors 110 with a carrier 412 and has a double row of fiber optic connectors 110. These ganged fiber optic connectors 110 can all be cleaned in a cleaner 500. See FIG. 7. There is an activation lever 510 that operates the pads and the cleaning cloth in the cleaner 500. While 12 fiber optic connectors 110 are illustrated, there can be more or fewer. There is an opening 506 in the top of the cleaner 500 to receive the fiber optic connectors 110. Within that opening are the pads 504 and cleaning cloth 502 ready to be used. See FIGS. 8 and 9. There may be other features of the cleaner 500, such as openings 508 for the guide pins of the fiber optic connectors 110, if there are any. A width of the cleaning cloth may then be such that the cleaning cloth fits between the guide pins without interference from the guide pins. Again, a single activation of the activation lever 510 simultaneously cleans the fiber optic connectors 110.

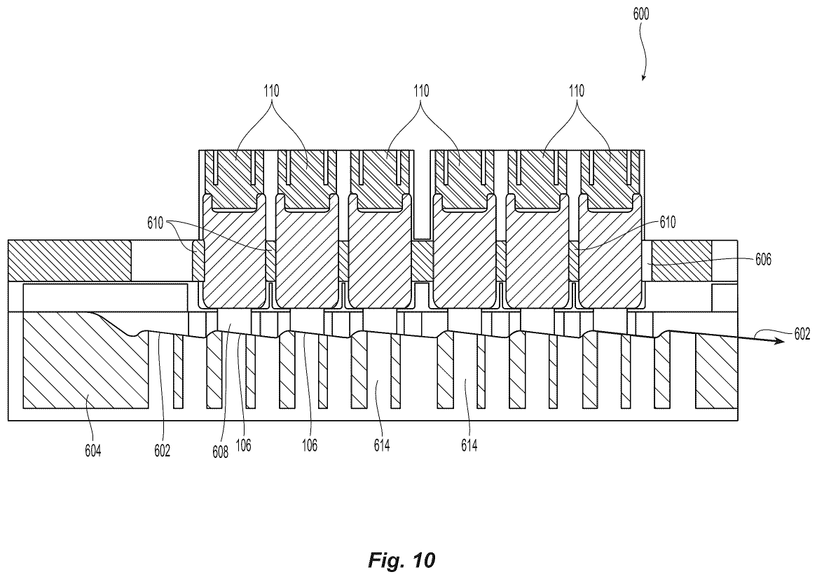

In FIG. 10 is a cross section of one cleaner 600 that can be used with the ganged fiber optic connectors 110. There is an opening 606 in the top of the cleaner 600 to receive the fiber optic connectors 110. Within that opening 606 are pads 604 and cleaning cloth 602 ready to be used. The pads 604 preferably have angled surfaces to match the angled surface of the end faces 106. The cleaning cloth 602 is pulled to the right and far enough so that new cleaning cloth 602 is exposed for every successive fiber optic connector 110 up to the last fiber optic connector 110 in the series with a single activation of the mechanism that moves the cleaning cloth 602. There may be other features of the cleaner 600, such as openings 614 for the guide pins of the fiber optic connectors 110, if there are any. Between each of the openings for the fiber optic connectors 110 are connector alignment features 610 to keep the fiber optic connectors 110 in alignment in the cleaner 600. See, e.g., FIG. 9.

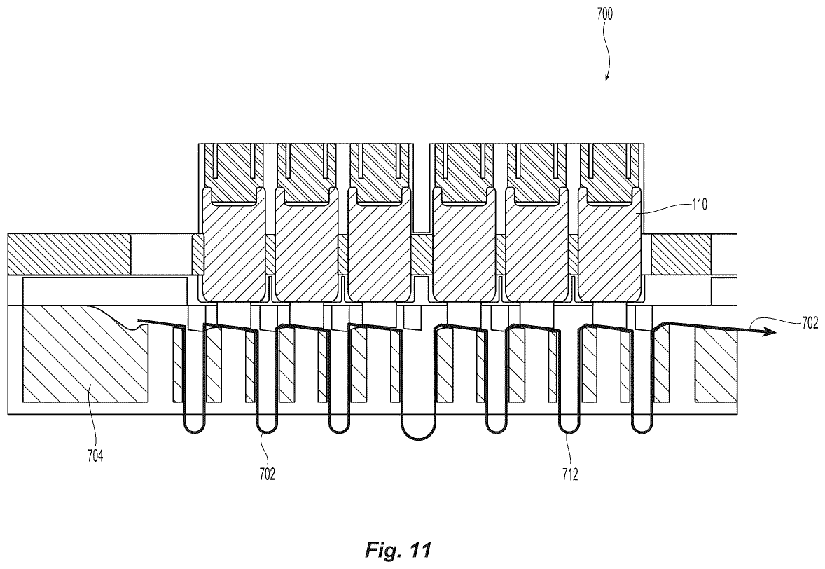

FIG. 11 illustrates another cleaner 700 that is similar to cleaner 600 with the pads 704 and the cleaning cloth 702 being quite similar. Other features that are in cleaner 600 are also clearly visible in cleaner 700, except cleaner 700 has loops of cleaning cloth 702 between each of the fiber optic connectors 110. The loops of cleaning cloth 702 allows for only a small movement of the cleaning cloth 702 to expose the next set of fiber optic connectors 110 to a new, clean portion of the cleaning cloth 702. It should be clear that after a certain number of cleanings, that the entirety of the length of cleaning cloth 702 will be dirty and a new set of cleaning cloth loops will have to be positioned in the cleaner 700. An advantage of this longer loop is that there is lesser relative movement of the cleaning cloth 702 and no portion of the cleaning cloth 702 is under two different end faces 106.

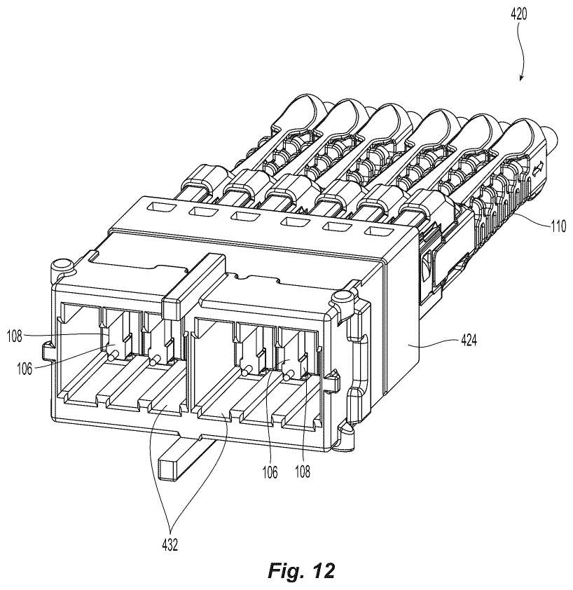

Also illustrated in FIG. 6 are a ganged set 420 of fiber optic connectors 110 that are in an adapter 424. There is also another ganged set 430 of fiber optic connectors 110 in an adapter 434. In these cases, the cleaner will need to be inserted into the adapters 424,434. As can be seen in FIG. 12, the adapter 424 has 6 fiber optic connectors 110 already installed. Each of the fiber optic connectors 110 is disposed within a connector port 432. The fiber optic ferrule 108 and the end face 106 are visible in the adapter 424.

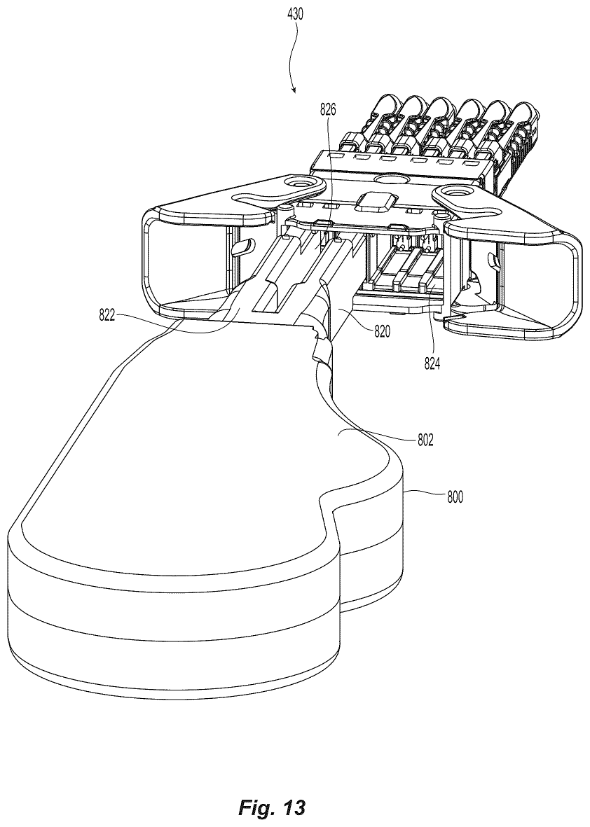

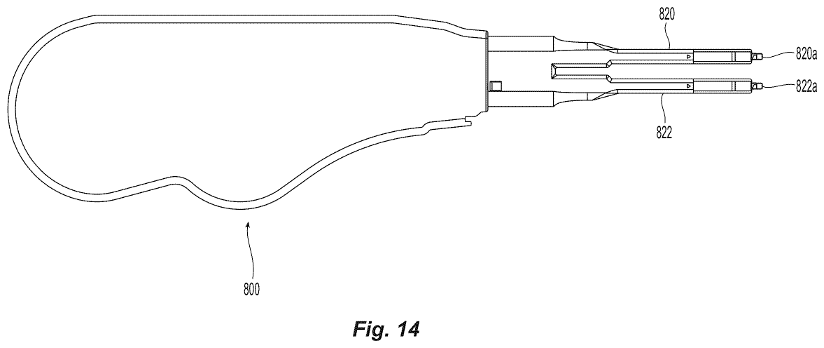

FIG. 13 has adapter 434 with the fiber optic connectors 110 pre-installed. The cleaner used with the adapters 424 and 434 can be the same. Such a cleaner 800 is illustrated in FIGS. 13 and 14. The cleaner 800 has a handle 802 within which the new and used cleaning cloth is stored, e.g., on one or more spools within the handle 802. The cleaner 800 has two extensions or nozzles 820,822. Each or only one of the extensions or nozzles 820,822 are flexible and allow some degree of movement relative to each other. Alternatively, one or both of the extensions or nozzles 820,822 may be rigid. Two cleaner tips 820a,822a are attached to the handle 802 via the extensions or nozzles 820,822 engage the fiber optic connectors 110 at the end faces 106, respectively. The cleaner tips 820a,822a are connected to an internal shaft (not shown) that is then connected to the body of the cleaner 800. The cleaning cloth is exposed to respective end faces at each of these two cleaner tips 820a, 822a. The adapter 434 has connector ports 824 to receive the fiber optic connectors 110. However, the extensions or nozzles 820,822 are too large to fit into adjacent connector ports 824 in the adapter 434. There is an open port 826 between the extensions or nozzles 820,822. See FIG. 13. Thus, the cleaner tips 820a, 822a have an open space or a separation therebetween. To use the cleaner 800, the cleaner would be inserted into the first and third ports to clean those fiber optic connectors 110. Then the cleaner 800 would be removed and inserted into the second and fourth ports. After cleaning those fiber optic connectors 110, the cleaner 800 would be inserted into the third and fifth ports, and then finally into the fourth and sixth ports. It should be noted that the third and fourth ports are used twice to clean all of the fiber optic connectors 110 in the adapter 424. Likewise, higher port adapters could also receive the two cleaner tips 820a, 820b.

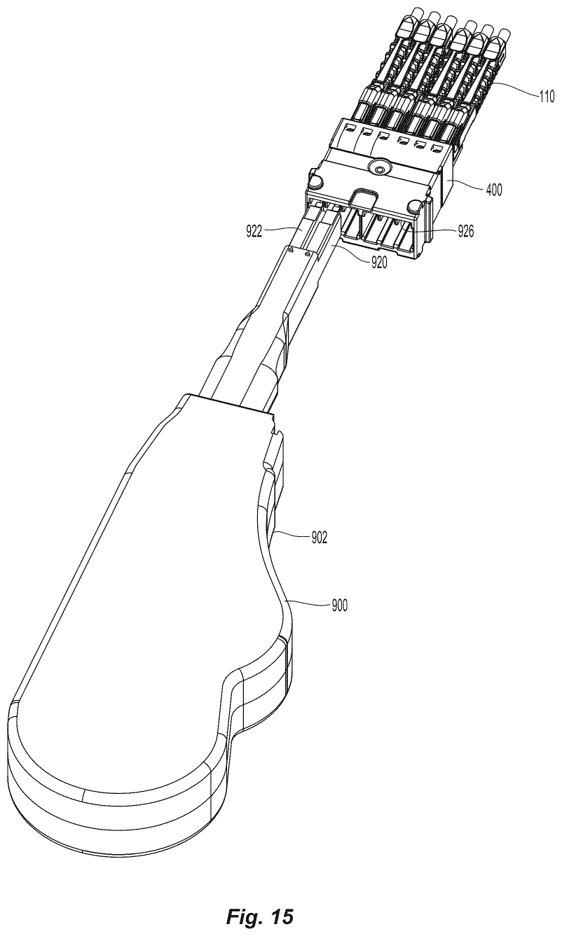

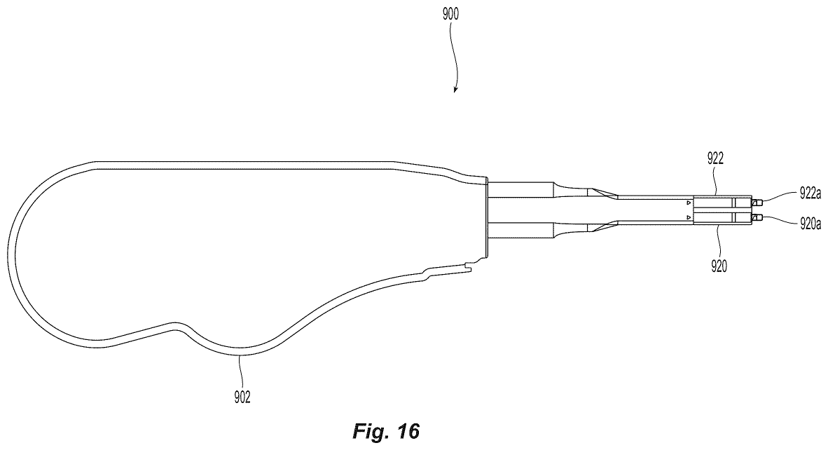

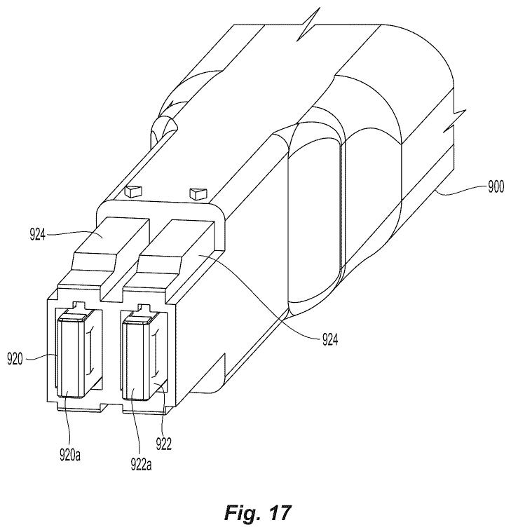

Turning to FIGS. 15-17, there is a cleaner 900 that is used to clean the end faces 106 of the fiber optic ferrules 108 in the fiber optic connectors 110. The cleaner 900 has a handle 902 and the extensions or nozzles 920,922 engage the fiber optic connectors 110 and the end faces 106. In this embodiment, the extensions or nozzles 920,922 are not separate elements, but rather a monolithic element with the cleaner tips 920a,922a to clean the end faces 106. Each of the extensions or nozzles 920,922 may also have a keying feature 924 that cooperates with the adapter 424,434 to ensure that the extensions or nozzles 920,922 are inserted correctly into the adapter 424,434. See, FIG. 17. In this case, the keying feature 924 is a raised shoulder that passes into the adapter when there is a corresponding pathway 926. If the cleaner 900 is positioned incorrectly the keying feature 924 will interfere with the external opening walls of the adapter 424,434, preventing the cleaner 900 from being used. Naturally, there may be other configurations for the keying feature or no keying feature at all (e.g., when the end faces 106 are flat and not angled). The cleaning cloth goes over each of these two cleaner tips 920a,922a.

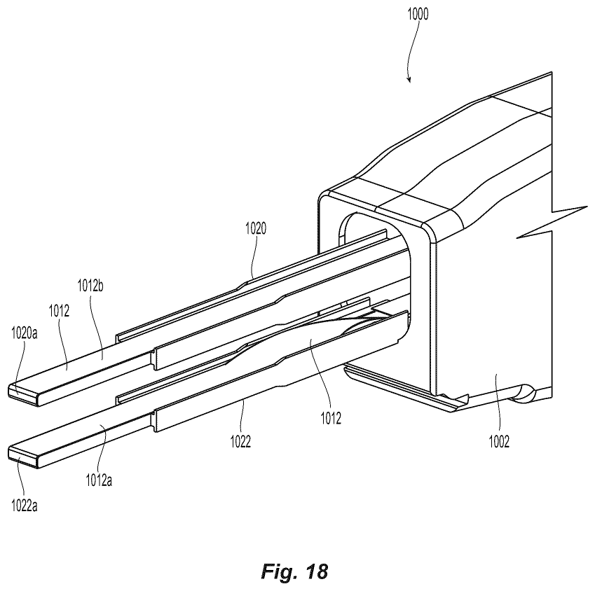

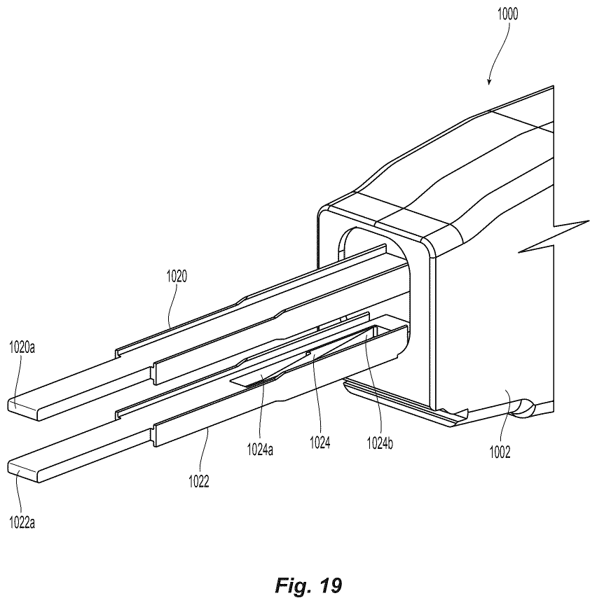

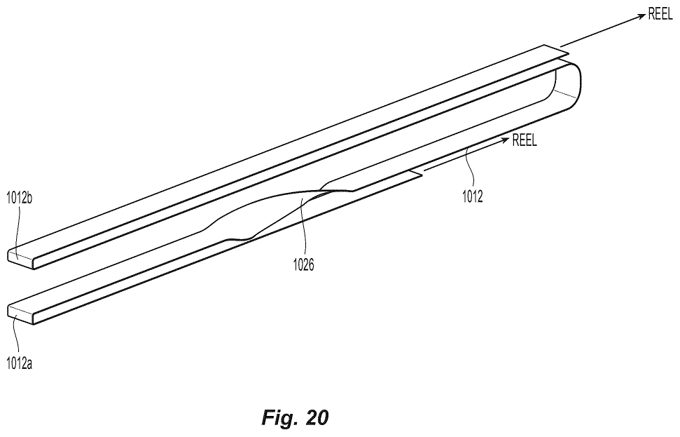

The cleaner 1000 is illustrated in FIGS. 18-20. The cleaner 1000 has a handle 1002, which may look like the other handles described and shown herein, but may also have a different configuration. The cleaner 1000 also has extensions or nozzles 1020,1022 that are used to the engage the end faces 106 of the fiber optic connectors 110. The extensions or nozzles 1020,1022 may also be used to twist or flip the cleaning cloth 1012, as noted later. Upon activation of the handle, a first side 1012a of the cleaning cloth 1012 cleans a first of the plurality of fiber optic connectors and a second side 1012b of the cleaning cloth 1012 cleans a second of the plurality of fiber optic connectors. The first side 1012a is opposite the second side 1012b of the cleaning cloth 1012, and thus, both sides of the cleaning cloth 1012 are efficiently used, instead of the conventional one side of the cleaning cloth 1012. A first end of the cleaning cloth 1012 is attached to a reel (not shown) inside the handle 1002, which is the supply wheel or a spool. In one embodiment, the cleaning cloth 1012 starts on the bottom side of extension or nozzle 1022 and travels around the cleaner tip 1022a and back towards the handle 1002. The portion of cleaning cloth 1022 that is used to clean the fiber optic ferrule is on the first side 1012a. As it moves, there is a twisting mechanism 1024 that twists the cleaning cloth 1012 by 180 degrees. See, e.g., FIG. 19. This twisting 1026 of the cleaning cloth 1012 allows for opposite sides of the cleaning cloth 1012 to be used in conjunction with the second tip 1020a and cleaning cloth 1012b. See FIG. 20. There are two openings 1024a and 1024b in the twisting mechanism that guides the twisted cleaning cloth 1012 along its path. The two openings 1024a,1024b may be triangular shaped although any appropriately sized opening or slot could be used to flip the cloth by 180 degrees. The twisting mechanism 1024 can be placed anywhere along the path from the first cleaner tip 1022a to the second cleaner tip 1020a, e.g., on one of the nozzles 1022 or as a separate element between the two nozzles 1022.

After the cleaning cloth 1012 moves past the twisting mechanism 1024, it proceeds into the handle 1002 and out on the extension or nozzle 1020 to the tip 1020a, where it is in a position to clean a fiber optic connector 100. The cleaning cloth 1012 then moves to handle 1002 and the take up reel for the dirty/used cleaning cloth. This pathway is also shown in FIG. 20. Naturally, the cleaning cloth 1012 could also be routed in the opposition direction as that just described. Thus, via the twisting mechanism 1024, both sides of the cleaning cloth 1012 are utilized resulting in less wastage.

Features of various embodiments herein may be used between the two embodiments. For example, the cam mechanism in one embodiment may be used instead of or in addition to the rotating belt in another embodiment to move the pad.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A cleaner for cleaning a plurality of fiber optic connectors, each fiber optic connector having fiber optic ferrule, comprising:
a main body including a mechanism to move at least one cleaner pad to respective positions adjacent the plurality of fiber optic connectors;
a cleaning cloth movable relative to the plurality of fiber optic connectors, wherein the cleaning cloth engages the cleaner pad when the cleaner pad is aligned with one of the end faces and also engages the end face of each of the fiber optic ferrules to clean the fiber optic ferrules upon a single activation of the mechanism;
wherein the plurality of fiber optic connectors are ganged together, and
wherein the end faces of the plurality of fiber optic ferrules are cleanable in succession one after the other with the single activation of the mechanism.

2. The cleaner according to claim 1, wherein the mechanism is a cam mechanism to move the at least one cleaner pad upward toward the end faces of the plurality of fiber optic connectors.

3. The cleaner according to claim 2, wherein the cam mechanism includes the at least one cleaner pad moving along a vertical axis.

4. The cleaner according to claim 3, wherein the cam mechanism includes the at least one cleaner pad being attached to a rotating belt.

5. The cleaner according to claim 4, wherein the rotating belt moves the at least one cleaner pad in a direction opposite to a direction of the cleaning cloth.

6. The cleaner according to claim 4, wherein the rotating belt moves the at least one cleaner pad in a direction that is the same as a direction of movement of the cleaning cloth.

7. The cleaner according to claim 2, wherein the cam mechanism is a rotating belt having a button attached to the rotating belt, the button engaging at least one cleaner pad associated with to move the at least one cleaner pad upward toward the end faces of the plurality of fiber optic connectors.

8. The cleaner according to claim 2, wherein the cam mechanism includes a cam shaft that moves the at least one cleaner pad upward toward the end faces of the plurality of fiber optic connectors.

9. The cleaner according to claim 1, wherein the cleaner is insertable into an adapter having at least one of the plurality of fiber optic connectors disposed therein.

10. The cleaner according to claim 1, wherein the plurality of fiber optic connectors ganged together are insertable into the main body of the cleaner.

11. A cleaner for cleaning a plurality of fiber optic connectors, each fiber optic connector having fiber optic ferrule, comprising:
a handle;
two cleaner tips attached to the handle, the cleaner tips having an open space or a separation therebetween; and
a cleaning cloth have a first side and a second side, the cleaning cloth moving from the handle to both of the two cleaner tips and back to the handle, wherein upon activation of the handle, the first side of the cleaning cloth simultaneously cleans a first of the plurality of fiber optic connectors and the second side of the cleaning cloth cleans a second of the plurality of fiber optic connectors.

12. The cleaner according to claim 11, further comprising a twisting mechanism to twist the cloth between a first of the plurality of fiber optic connectors and a second of the plurality of fiber optic connectors.

13. The cleaner according to claim 11 wherein a first of the plurality of fiber optic connectors and a second of the plurality of fiber optic connectors are disposed within an adapter.

14. The cleaner according to claim 13, wherein there is at least one connector port of the adapter between the first of the plurality of fiber optic connectors and the second of the plurality of fiber optic connectors.

15. The cleaner according to claim 13, wherein the cleaner has at least one keying feature that cooperates with a keying feature on the adapter.
